(19) United States
(12) Patent Application Publication
(10) Pub. No.: US 2024/0287629 A1
(43) Pub. Date: Aug. 29, 2024

(54) MAPLE SYRUP MAKING SYSTEM, FILTERPRESS APPARATUS AND MAPLE SYRUP FILTERING PROCESS

(71) Applicant: DOMINION & GRIMM INC., Anjou (CA)

(72) Inventors: Jocelyn LARIVIÈRE, St-Prosper-de-Dorchester (CA); Éric VACHON, St-Prosper-de-Dorchester (CA); Vincent PÉPIN, Laval (CA)

(21) Appl. No.: 18/585,827

(22) Filed: Feb. 23, 2024

Related U.S. Application Data
(60) Provisional application No. 63/486,572, filed on Feb. 23, 2023.

(51) Int. Cl. C13B 20/16

(52) U.S. Cl. CPC C13B 20/165

(57) ABSTRACT

The maple syrup filtering process includes generating pressure with a variable power output pump to generate a flow of maple syrup in a filterpress apparatus from an inlet to an outlet. The maple syrup is filtered with a filtering medium as it flows between the filterpress inlet and outlet, to generate filtered maple syrup. Fluid pressure of the maple syrup is monitored with a pressure sensor located upstream of the filtering medium. The fluid pressure might fluctuate as a result of a composition of the unfiltered maple syrup or the level of clogging of the filtering medium. A variable power output of the pump is automatically controlled with a controller responsive to fluctuations in fluid pressure monitored with the pressure sensor to achieve a target pressure measured at the pressure sensor. The filterpress apparatus can include a series of filters through which the maple syrup is filtered.

### CROSS-REFERENCE TO RELATED APPLICATIONS

This application claims the benefit of U.S. Provisional Application No. 63/486,572, filed on Feb. 23, 2023. The entire disclosure of the above application is incorporated herein by reference.

### FIELD

The present technology relates to maple syrup and, more particularly, to the systems, apparatuses, and processes for making and filtering maple syrup.

### INTRODUCTION

This section provides background information related to the present disclosure which is not necessarily prior art.

The term “nutraceutical” combines the two words of “nutrient,” which is a nourishing food component, and “pharmaceutical,” which is a medical drug. Nutraceuticals are grouped into four categories that include dietary supplements, functional food, medicinal food, and pharmaceuticals. Functional food includes whole foods and fortified, as well as enriched or enhanced dietary components that may reduce the risk of chronic disease and provide health benefits beyond the traditional nutrients it contains, such as lowering the risk for development of cardiovascular diseases, being cardioprotective, antioxidant, anti-inflammatory, anti-cancer and antimicrobial properties. Maple syrup from for example sugar maple (Acer saccharum M.) also has nutraceutical potential given the macronutrients (carbohydrates, being primarily sucrose), micronutrients (minerals and vitamins), and phytochemicals (primarily phenolics) found therein. Compositional (ash, fiber, carbohydrates, minerals, amino acids, organic acids, vitamins, phytochemicals) studies on maple syrup reveal a number of phytochemicals providing antioxidant and anti-inflammatory effects. High mineral intake and rapid metabolism by the human body with maple syrup also provide health benefits.

The Canadian province of Quebec is the world' largest maple syrup producer, supplying on average about 70% of the world's production. In 2020, the value of Quebec's international maple syrup exports was CAN $497 million. Main destinations for Quebec's maple product exports are the United States (60%), the European Union (27%), Australia (5%) and Japan (4%).

Maple syrup's unique taste makes it an ingredient of choice for chefs and foodies around the world. The North American standard for grading maple syrup categorizes syrup according to color and taste. These characteristics evolve throughout the season. The four classes of maple syrup are: golden—delicate taste; amber—rich taste; dark—robust taste; and very dark—strong taste.

Maple syrup is a syrup made from the sap of maple trees. In cold climates such as in Canada, maple trees store starch in their trunks and roots before the subfreezing winter season; the starch is then converted to sugar. As daily above/below maple sap freezing point temperature cycles occur during early spring, maple trees can be tapped by drilling holes transversely into their trunks so as to collect the maple sap, which is thereafter processed by heating to evaporate much of the water, leaving the concentrated maple syrup.

Maple syrup is usually produced by open pan evaporation methods from maple sap first being collected and boiled down to obtain syrup. Maple syrup is made by boiling between 20 and 50 volumes of maple sap (depending on its concentration) over a heat source until one volume of syrup is obtained, usually at a temperature 4.1° C. (7.4° F.) over the boiling point of water. As the boiling point of water varies with changes in altitude (air pressure), the correct value for pure water is determined at the place where the syrup is being produced, each time evaporation begins and periodically throughout the day. Syrup can be boiled entirely over one heat source, or can be drawn off into smaller batches and boiled at a more controlled temperature.

Boiling the maple syrup is a more or less controlled process, which should try to ensure appropriate sugar content. Syrup boiled too long will eventually crystallize, whereas under-boiled syrup will be watery and will quickly spoil. The finished maple syrup has an optimal density of about 66° on the Brix scale.

A recurring problem with conventional maple syrup processes is the variability of compositional quality, i.e., the syrup composition is not stable through production cycles.

The maple syrup is then filtered to remove microparticulate components, including any debris that might be in the syrup, but also precipitated “sugar sand” crystals. These sugar sand crystals are not toxic but create a “gritty” texture in the syrup if not filtered out. Filtration is a physical separation process that separates solid matter from fluids in a mixture using a filter medium through which only the fluid can pass. Solid particles that cannot pass through the filter medium are described as oversized particles and the fluid that passes through is called the filtrate.

FIG. 1 shows a prior art maple syrup making process enabled by a syrup making system 19, wherein collected maple tree sap is conveyed by standard tubing equipment into a number of evaporator pans 20 of an evaporator 21. Evaporator pans 20 are mounted over a heat generating boiler machine 22. Maple sap is circulated in evaporator 21 to evaporate water from the maple sap in a determined proportion to obtain maple syrup having a desired high sugar concentration therein. In this way, sugar concentration of maple sap is increased by for example 40 to 50 times, to reach a more or less optimal maple syrup concentration. Inlet 24A of an unfiltered syrup tank 24 is connected to the outlet 26 of the evaporator 21 via a first fluid tube 28 to convey unfiltered syrup from evaporator 21 to unfiltered fluid tank 24.

A fixed speed fluid pump 30 is mounted along a second fluid tube 36 and functions at its rated speed to generate pressure to convey fluid between outlet 24B of fluid tank 24 towards an inlet 32 of a filterpress apparatus 34. Maple syrup liquid matrix is filtered in filterpress apparatus 34, i.e., some sugar sand and other macroparticulate components of the maple syrup are at least partly removed from the liquid state syrup. A third fluid tube 38 interconnects purified maple syrup fluid outlet 40 of filterpress apparatus 34 to a filtered maple syrup storage collector fluid tank 42 wherein the filtered maple syrup is accumulated and stored before shipping.

According to the prior art system and process of FIG. 1, the filterpress apparatus 34 comprises a stack of filtering frames 34a (schematically shown in FIG. 1) between which a filtering medium such as sheet filters (not shown) are provided. The maple syrup matrix is fed simultaneously into all frames of the stack of frames 34a and fills inner chambers (not shown) between frames 34 before being forced, by fluid pump 30, through the sheet filters and then out into third fluid tube 38.

The maple syrup liquid matrix is of variable composition: it may comprise a variable quantity per volume of macroparticulate components of course, but over and above that, the maple syrup liquid matrix itself will vary depending on at least a few other factors such as what sugar bush is being tapped (since each might yield different maple water compositions), the time of the season at which the maple sap is being collected (maple sap composition varies depending on whether it is early or late in the maple sugar season), the evaporator 21 output which may vary for a same maple sap, and so on.

A consequence of the variable composition of the unfiltered maple syrup liquid matrix is that the filtration through filterpress 34 will not occur the same way. Particularly, the viscosity of the maple syrup will vary depending on its composition, as will the filtration requirements depending on whether the liquid matrix comprises a high concentration of sugar sands.

Also, some inherent operation parameters in filterpress apparatus 34 will also vary during the filtering process. For one, the temperature of filterpress apparatus is not always the same: when a first batch of maple syrup liquid matrix is to be processed from unfiltered tank 24, filterpress apparatus 34 is initially cold and the temperature of the incoming hot maple syrup liquid matrix will be lowered by the cold filterpress apparatus frames 34a and the cold tubing 36. Cooler maple syrup means that its viscosity will be higher, increasing the pressure required to force the maple syrup through the filtering medium. Also, as the filtering medium becomes gradually clogged with particles, the pressure required to force the maple syrup through the filtering medium will also be higher. Likewise, whether siliceous sedimentary rock powder, also known as diatomaceous particles, are being used within frames 34a as a further filtration medium in addition to the sheet filters, might also increase the pressure required to process the maple syrup through the filterpress apparatus 34. And of course, as the diatomaceous particles become clogged with particulate debris, additional pressure is also required.

Pressure pump 30 in prior art systems are of the fixed speed type, as mentioned above. This means that the it operates at its rated speed regardless of the maple syrup flow conditions. If the filters are clogged, or if the maple syrup is particularly viscous due to it being cooler or having a higher concentration of sugars sands, pump 30 will still function at a same speed despite the (un-monitored) pressure increasing inside the filterpress apparatus. The filtration process will consequently not occur evenly depending on whether the actual pressure inside the filterpress apparatus 34 is lower or higher. Even if the adjustment of the pressure at pump 30 were to be done in the prior art process, this would require that a person visually inspects the output of filtered maple syrup and manually operate the pump 30. This would be time consuming and require the very delicate and difficult task of transforming a qualitative inspection of the maple syrup into a quantitative value at pump 30. Importantly, this could not be made in real time because it is the actual output of a visually recognized inadequate filtered maple syrup at collector tank 42 that would allow the operator to conclude that the pump 30 is not adjusted at the right pressure value. Moreover, once an inadequate output at collector tank 42 is recognized, would come the trial-and-error iterative process of manually adjusting pump 30 until a desired result is obtained.

In practice, the lack of any adjustment at pump 30, or inadequate manual adjustments by an operator based on after-the-fact filtration from maple syrup output observation, results in filtered maple syrup batches at collector tank 42 that have variable compositions and quality, due to an uneven filtering process. This is problematic since the composition of filtered syrup needs to be very precisely controlled for it to meet industrial and regulatory quality standards.

Accordingly, there is a continuing need for systems, apparatuses, and processes for making and filtering maple syrup that provide improved filtering of maple syrup.

### SUMMARY

In concordance with the instant disclosure, the present invention aims to rectify and resolve the above-mentioned problems, and generally to improve upon existing maple syrup filtration systems and processes and filterpress apparatuses.

The present technology includes articles of manufacture, systems, and processes that relate to making and filtering maple syrup.

In one embodiment, the present invention pertains to a maple syrup filtering process for filtering an unfiltered maple syrup liquid matrix in a maple syrup filtering system. The maple syrup filtering process that can include providing a filterpress apparatus and a variable power output pump and generating pressure with the pump to generate a flow of maple syrup in the filterpress apparatus from an inlet of the filterpress apparatus where the maple syrup liquid matrix is fed to an outlet where filtered maple syrup is collected. The maple syrup filtering process that can also include filtering the flow of maple syrup inside the filterpress apparatus with a filtering medium as it flows between said filterpress inlet and outlet, to generate the filtered maple syrup from the unfiltered maple syrup liquid matrix; monitoring fluid pressure of the maple syrup liquid matrix with a pressure sensor located upstream of the filtering medium, which fluid pressure might fluctuate as a result of at least one of a composition of the unfiltered maple syrup liquid matrix and the level of clogging of the filtering medium; and automatically controlling, with a controller, a variable power output of the pump responsively to fluctuations in fluid pressure monitored with said pressure sensor to achieve a target pressure measured at said pressure sensor.

In certain embodiments, the target pressure can be constant.

In certain embodiments, the target pressure can vary depending on at least one of the maple syrup composition, the filtering medium clogging, and the filterpress apparatus temperature variations.

In certain embodiments, the maple syrup filtering process can include the step of monitoring a first fluid temperature of the unfiltered maple syrup liquid matrix with a first temperature sensor located downstream of the filtering medium, the first fluid temperature being indicative the viscosity of the maple syrup at the outlet, wherein the step of automatically controlling, with the controller, the variable power output of the pump is also accomplished responsively to fluctuations in the first fluid temperature monitored with the first temperature sensor.

In certain embodiments, the maple syrup filtering process can include the step of monitoring a second fluid temperature of the filtered maple syrup with a second temperature sensor located upstream of the filtering medium, the temperature differential between the first fluid temperature and the second fluid temperature being indicative of a temperature loss within the filterpress apparatus, wherein the step of automatically controlling, with the controller, the variable power output of the pump is also accomplished responsively to this temperature differential.

In certain embodiments, the pump can be located upstream of the filtering medium and the pressure sensor can be located downstream of the pump.

In certain embodiments, the pump can be located upstream of the filtering medium and the pressure sensor and the second temperature sensor can be located downstream of the pump.

In certain embodiments, the filtering medium can include filter sheets through which the maple syrup flows.

In certain embodiments, said filterpress apparatus can include a stack of frames that can have a number of frames and separation panels each located between two corresponding said frames, with said filter sheets each being disposed between a frame and a separation panel, first chambers formed within said frames and bordered by said filter sheets, second chambers formed within said separations panels and being also bordered by said filter sheets, wherein the step of generating pressure with the pump to generate a flow of maple syrup in said filterpress apparatus from the inlet to the outlet comprises circulating the maple syrup successively through said first chambers and then through said second chambers, and the step of filtering the flow of maple syrup inside the filterpress apparatus comprises the maple syrup flowing through said filter sheets when it flows from a first chamber into a second chamber.

In certain embodiments, said separation panels can have an uneven surface to help avoid flat engagement of said filter sheets against the separation panel surface.

In certain embodiments, the filtering medium further can include diatomaceous powder located in at least some of said first chambers through which the unfiltered maple syrup flows.

The invention also relates to a maple syrup filterpress apparatus for filtering particles from an unfiltered maple syrup liquid matrix. The filterpress apparatus can include a housing, a number of interconnected first and second chambers within said housing, filtering mediums each between one of said first chambers and one of said second chambers for filtering particles in the liquid matrix as it flows from said first chambers to said second chambers, an unfiltered maple syrup liquid matrix inlet connected to at least one of said first chambers for allowing the unfiltered maple syrup liquid matrix to be fed to said at least one of said first chambers that is connected to said inlet, a filtered maple syrup outlet connected to at least one of said second chambers for allowing filtered maple syrup to be collected from said at least one of said second chambers that is connected to said outlet, and a pump generating pressure in said housing to force maple syrup to flow from said inlet, through said first and second chambers with said maple syrup being filtered as it passes from said first chambers to said second chambers by said filtration mediums, and out through said outlet, wherein at least part of the maple syrup flows from one of said second chambers into one of said first chambers whereby the maple syrup is filtered in series by at least two of said filtering mediums.

In certain embodiments of the maple syrup filterpress apparatus, between said at least one of said first chambers which is connected to the inlet and said at least one of said second chambers connected to the outlet, said maple syrup flows alternately from said first chambers into said second chambers a number of times to be filtered in series by all filtration mediums.

In certain embodiments of the maple syrup filterpress apparatus, the filtration medium can include filter sheets each disposed between corresponding ones of said first and second chambers.

In certain embodiments of the maple syrup filterpress apparatus, the porosity of said filter sheets can have a value ranging between 5 to 500 micrometers.

In certain embodiments of the maple syrup filterpress apparatus, the porosity of said filter sheets can decrease between higher upstream porosity values to lower downstream porosity values in said filterpress apparatus.

In certain embodiments of the maple syrup filterpress apparatus, said filtering medium can include a diatomaceous powder in at least some of said first chambers.

In certain embodiments of the maple syrup filterpress apparatus, a granulometry of said diatomaceous powder can range between 5 and 1,000 micrometers.

In certain embodiments of the maple syrup filterpress apparatus, said housing can include a stack of frames that can have a number of frames, and separations panels each located between two corresponding said frames, with said filter sheets each being disposed between a frame and a separation panel, with said first chambers being formed within said frames and bordered by said filter sheets, with said second chambers being formed within said separations panels and being also bordered by said filter sheets.

In certain embodiments of the maple syrup filterpress apparatus, said separation panels can have an uneven surface to help avoid flat engagement of said filter sheets against the separation panel surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a prior art maple syrup concentration system that enables a maple syrup concentration process from maple sap collected in an upstream boiler evaporator pan, via an intermediate fluid pump fed filterpress, to a downstream maple syrup storage unit barrel;

FIG. 2 is a schematic view of a fluid concentration system enabling a maple syrup filtration process according to the present invention, showing a first embodiment of a syrup filterpress apparatus according to the invention;

FIG. 3 is an enlarged downwardly looking perspective view of the syrup filterpress apparatus used in the system of FIG. 2 and according to the invention;

FIG. 4 is an enlarged partly exploded perspective view of the stack of frames of the filterpress apparatus of FIG. 3;

FIG. 5 is an enlarged exploded perspective view, from a perspective at 180° relative to FIG. 4, of one frame, one filter sheet and one separation panel of the stack of frames of FIG. 4;

FIG. 6 is an enlarged view of a section of corrugated panel circumscribed by circle VI of FIG. 5;

FIG. 7 is a front elevation, at a reduced scale, of the frame stack of FIG. 4;

FIG. 8 is an enlarged schematic cross-sectional top plan view of the frame stack of FIGS. 4-7, taken along line VIII-VIII of FIG. 7, and suggesting by fluid ingress arrows F1 and F3 and fluid egress arrow F2 fluid flow through patterns into and outwardly thereof, in a parallel fluid flow mode embodiment;

FIG. 9 is a view similar to FIG. 7, but showing the full end panel of a second embodiment of the frame stack;

FIG. 10 is a schematic sectional perspective view similar to FIG. 8, taken along line X-X of FIG. 9, but showing a filterpress apparatus according to a series mode fluid flow embodiment, and suggesting by fluid arrows F4, F5, F6 the fluid flow through series mode patterns into the frame stack;

FIG. 11 is a view similar to FIGS. 7 and 9, but showing the full end panel of a third embodiment of the filterpress apparatus;

FIG. 12 is a schematic view similar to FIGS. 8 and 10 taken along lines XII-XII of FIG. 11, but suggesting by fluid arrows F9, F10, F11, F12 and F13 the fluid flow through patterns of a hybrid mode embodiment; and

FIG. 13 is a view similar to FIG. 2 but showing another embodiment of the invention wherein the syrup filtration system has three filtering filterpress apparatuses connected to one another in series.

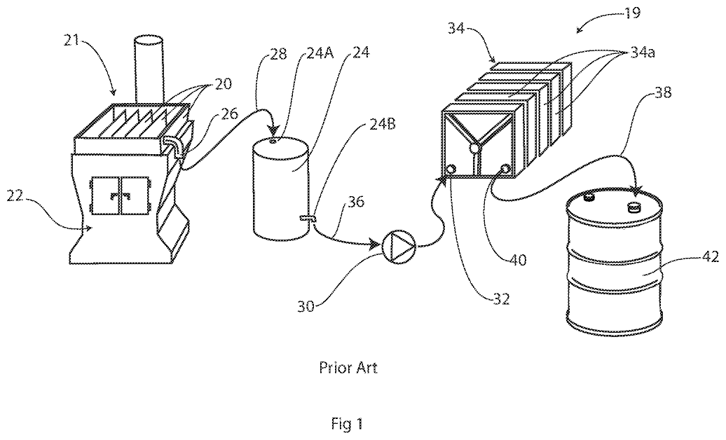

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,”“engaged to,”“connected to,” or “coupled to” another element or layer, it may be directly on, engaged, connected or coupled to the other element or layer, or intervening elements or layers may be present. In contrast, when an element is referred to as being “directly on,”“directly engaged to,”“directly connected to” or “directly coupled to” another element or layer, there may be no intervening elements or layers present. Other words used to describe the relationship between elements should be interpreted in a like fashion (e.g., “between” versus “directly between,”“adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,”“second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,”“outer,”“beneath,”“below,”“lower,”“above,”“upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the systems and processes for making and filtering maple syrup.

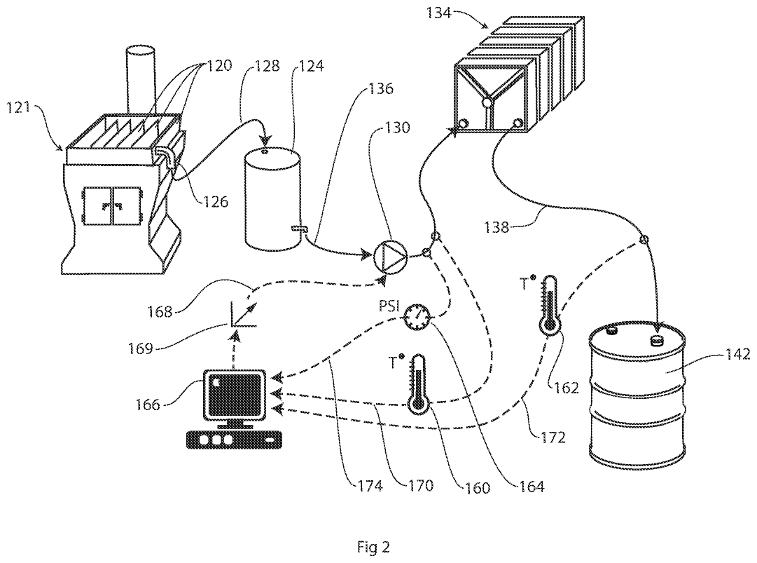

FIG. 2 shows a syrup making system according to the present invention that comprises an evaporator 121 having evaporator pans 120, a downstream end of which is connected to an unfiltered maple syrup tank 124 by a first conduit 128 via an outlet 126. The liquid matrix component-laden syrup from tank 124 is conveyed, with the help of a variable output debit, a.k.a. a variable speed, pump 130, to a filterpress apparatus 134 through a second conduit or fluid line 136, where the maple syrup will be filtered as described further below. Filtered maple syrup exiting filterpress apparatus 134 is conveyed by a third conduit or fluid line 138 into a filtered syrup collector tank 142.

Thermometers 160, 162 or other temperature sensors are operatively connected to fluid lines 136, 138 to monitor fluid temperatures respectively upstream and downstream of filterpress apparatus 134, while a pressure sensor 164 is operatively connected to and monitors fluid pressure in fluid line 136 upstream of filterpress apparatus 134. Both pressure sensor 164 and thermometer 160 are installed upstream of filterpress apparatus but downstream of pump 130. Input data from thermometers 160, 162 and pressure sensor 164 is fed into a controller 166 via data communication lines 170, 172, and 174 respectively, which may be wired or wireless. Controller 166 may be of any suitable type for automatically controlling the fluid pressure power output adjustments 169 at variable power output pump 130 via a data communication line 168, which may be wired or wireless, whereby power output of pump 130 may be automatically adjusted in continuous real-time mode as a consequence of measured pressure at pressure sensor 164 and measured temperatures at thermometers 160, 162—as detailed below. In one embodiment, controller 166 may include a CPU. In one embodiment, controller 166 is a computer as depicted in FIG. 2.

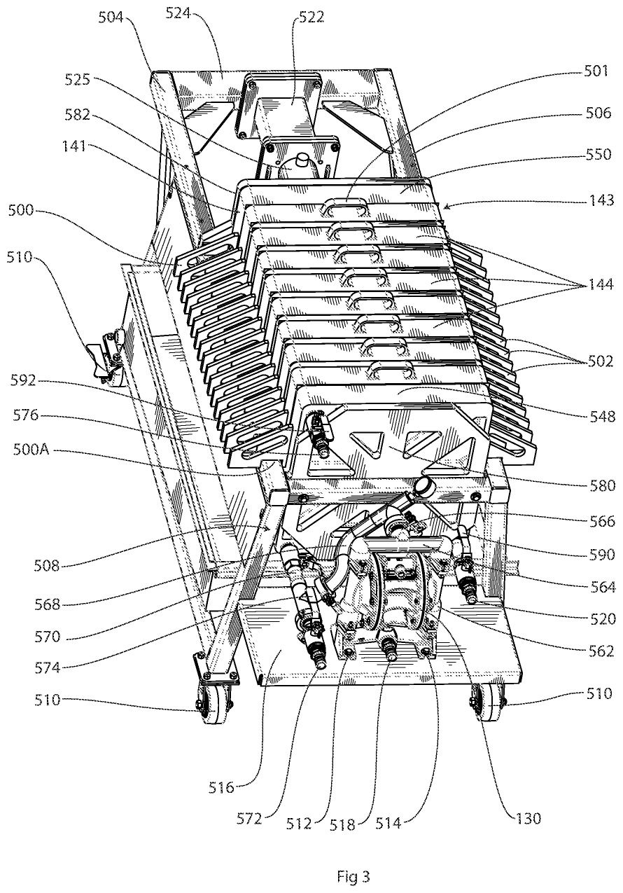

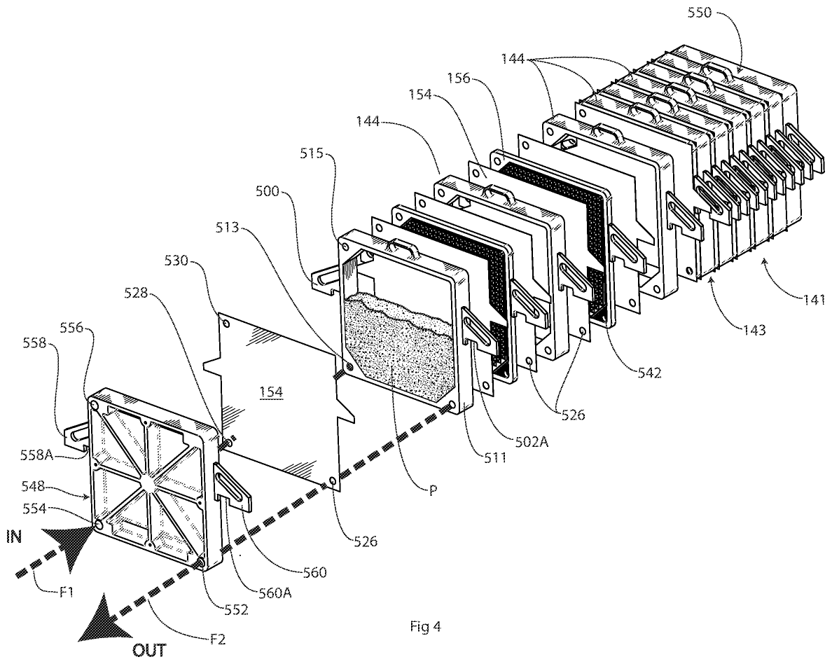

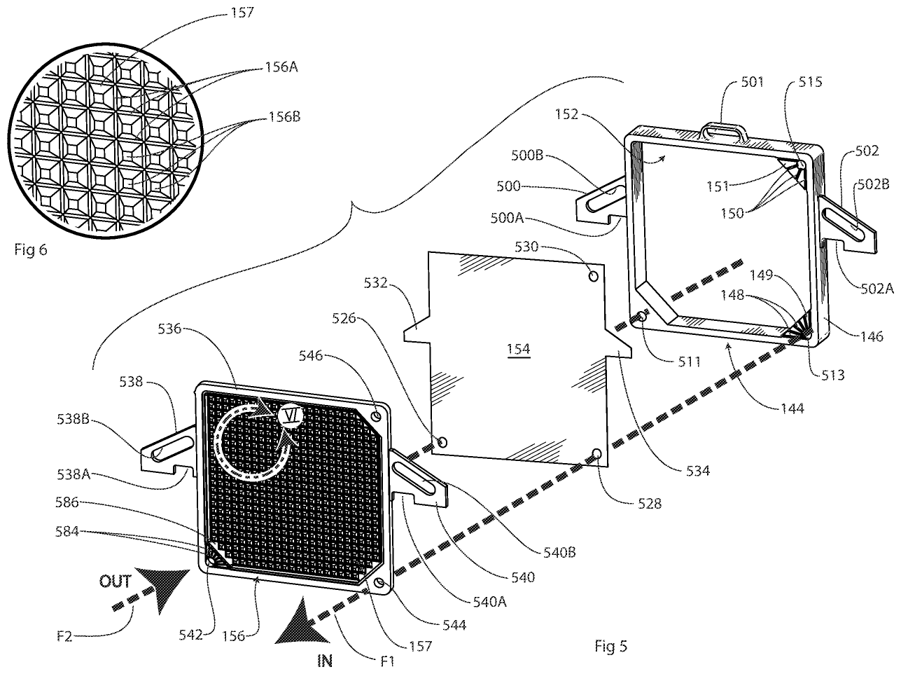

FIGS. 3 to 6 illustrate one embodiment of filterpress apparatus 134 according to the present invention. Filterpress apparatus 134 includes a housing 141 that comprises a stack 143 of quadrangular frames 144 each defining a peripheral wall 146 circumscribing a first unfiltered maple syrup inner chamber 152, which will be detailed below. Bores 511, 513 are made transversely of the two bottom corners of each frame 144, and a bore 515 is made transversely of one top corner of each frame 144, for fluid flow through axially along axial channels that are respectively formed by the axially aligned bores 511, 513, 515 of the stack of frames 143. Radially extending channels 148 made on one side of a corner tab 149 of frame peripheral wall 146 (see FIG. 5) link bore 513 to inner chamber 152 and radially extending channels 150 made on one side of another corner tab 151 of frame peripheral wall link bore 515 to inner chamber 152.

Optionally, as shown in FIG. 4, siliceous sedimentary rock powder P such as for example diatomaceous particles P fills at least partially some or all frame inner chambers 152, for enhancing maple syrup liquid matrix filtering. Granulometry of powder P may range e.g., between 5 and 1000 micrometers ( μm), and preferably between 10 and 100 μm, and most preferably between 80 to 100 μm.

Peripheral wall 146 of each frame 144 carries opposite lateral support brackets 500, 502, outwardly projecting therefrom in opposite directions. Each support bracket 500, 502, includes an ovoidal slot 500B, 502B, and a bottom notch 500A, 502A respectively, the latter notches sized and shaped to releasably engage atop horizontal support rails 504, 506 respectively for support and alignment of frames 144. Rails 504 and 506 are made integral to an upper portion of a carriage 508 (FIG. 3). Idle rollers 510, e.g., two pairs of opposite idle rollers 510, 510, rollably support carriage 508 over ground.

A handle 501 is provided at the top of frame peripheral wall 146 to allow handling frames 144 for installation, cleaning, maintenance, and replacement.

The pump 130 shown schematically in FIG. 2 is further shown in FIG. 3, albeit without any housing to help avoid concealing other components in FIG. 3. The pump 130 is fixedly mounted to a support platform 516 integral to frame carriage 508 by anchor legs 512, 514, at a front end of the frame stack 143. Unfiltered raw maple syrup liquid matrix from fluid line 136 is fed to the pump 130 via a fluid intake port 518, while filtered pure maple syrup escapes from fluid press apparatus via a fluid outlet port 520.

A hydraulic cylinder 522 is transversely mounted to a carriage frame anchor bar 524 which integrally transversely interconnects rails 504 and 506 at their aft ends opposite frontward located fluid pump 518. A reciprocating piston rod 525 extends from cylinder 522 and engages and abuts transversely against a downstream full panel 550 (FIG. 3).

Frame stack 143 further comprises a paper filter sheet 154 disposed on either side of each frame 144. Each filter sheet 154 is sized and shaped to abut against a corresponding side of the frame peripheral wall 146 such that it covers the entire area that is in facing register of the inner chamber 152 of frame 144. Each filter sheet 154 includes three peripheral corner bores 526, 528 and 530 adapted to axially register with frame bores 511, 513 and 515 respectively.

The porosity of paper filter sheet 154 may range for example between 5 and 100 μm; in one embodiment, the porosity of filter sheet 154 is of approximately 20 μm; in another embodiment, the porosity of successive filter sheets 154 decreases progressively from a maximum value up to 100 μm to a minimum value down to 5 μm between an upstream frame 144 and a downstream frame 144 of the filterpress apparatus 134 (more on variable filter porosities in the description of the series mode filterpress apparatus embodiments, below). Paper filter sheet 154 screens macro-particulate components such as granular sugar sand and other particulate components from the maple syrup liquid matrix, whereby the filtrate escaping through filterpress apparatus outlet 140 becomes purified high quality maple syrup, as detailed below.

The opposite lateral edges of each filter sheet 154 include two opposite outwardly projecting flexible flaps 532, 534 adapted to extend outwardly of peripheral walls 146 of frames 144 which allows abutment against rails 504, 506 to support and align the filter sheets 154 during installation. Filter sheets ideally have sufficient rigidity to facilitate such abutment.

Stack of frames 143 further comprises a number of fluid tight separation panels 156 each disposed between a pair of frames 144. Each corrugated panel 156 is fluid-tight thus preventing through transverse passage of maple syrup. Each separation panel 156 includes a peripheral portion 536, from two opposite lateral sides of which outwardly project support brackets 538, 540. Each of brackets 538, 540 includes a bottom notch 538A, 540A, sized and shaped for supporting engagement and alignment with carriage support rails 504, 506, and an ovoidal slot 538B, 540B aligned with slots of frame brackets 500,502.

Panel peripheral portion 536 is sandwiched between and abuts against a corresponding side of the two adjacent frame peripheral walls 146. As suggested in FIGS. 5, 6 and 8, each panel 156 further comprises an interior wall 157 located interiorly of peripheral portion 536. Optionally, panel interior wall 157 has an uneven, e.g., corrugated, surface as shown in the larger scale FIG. 6, that defines a plurality of troughs 156A and crests 156B. Furthermore, interior wall 157 is recessed comparatively to peripheral portion 536, i.e., peripheral portion 536 projects beyond interior wall 157, on both sides of panel 156. A second filtered maple syrup chamber 158 is defined on either side of interior wall 157 in the recessed area interiorly of peripheral portion 536—more on this second chamber 158 below.

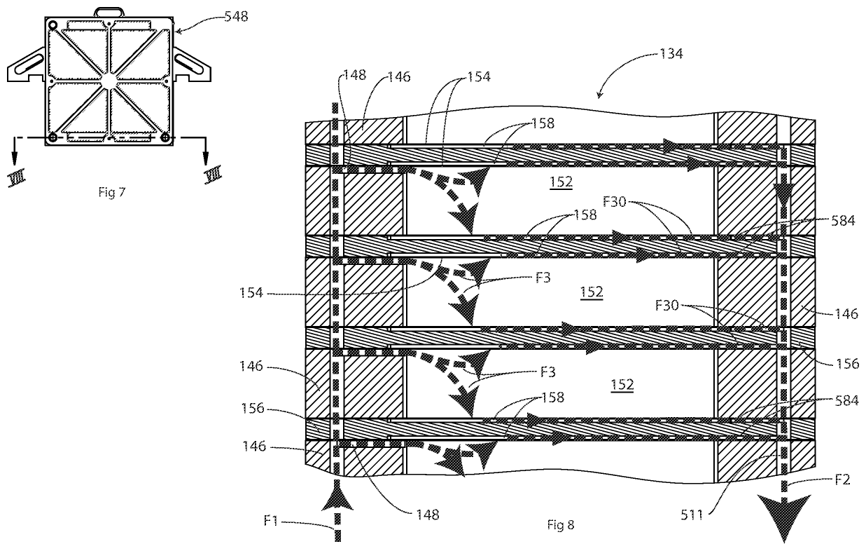

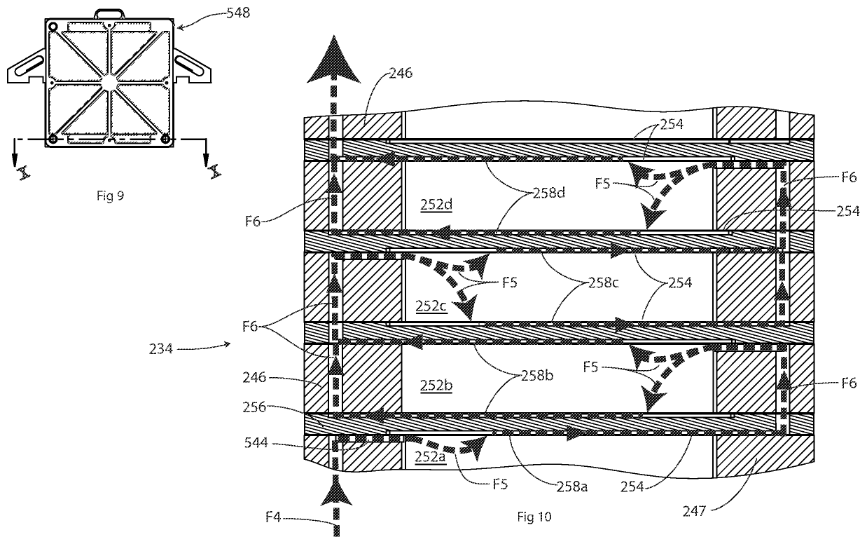

Radially extending channels 584 made on both sides of a corner tab 586 of panel peripheral portion 536 link bore 542 to both inner chambers 158 formed on either side of panel interior wall 157. FIGS. 4 and 5 show the channels 584 on a same side of panel 156, while FIG. 8 shows the channels 584 on both sides of panel peripheral portion 536.

Each panel 156 is sized and shaped to fully engage, on either side of it, a corresponding filter sheet 154, and to take in sandwich between its peripheral portion 536 and the peripheral wall 146 of a corresponding frame 144. I.e., such a filter sheet 154 is disposed on either side of each frame 144 and is thusly sandwiched between that frame 144 and a corresponding panel 156. Each first unfiltered maple syrup chamber 152 is consequently more particularly defined interiorly of frame peripheral wall 146 between a pair of filter sheets 154. And, due to the recessed configuration of interior wall 157 of panel 156, each second filtered maple syrup chamber 158 is more particularly defined on each side of each panel 156, interiorly of peripheral portion 536 and between a corresponding filter sheet 154 and interior wall 157.

The uneven corrugated surfaces of interior wall 157 form an irregularly shaped continuous interspacing so that even if the unfiltered maple syrup in unfiltered syrup chamber 152 pushes filter sheet against panel interior wall 157, and even if the soaked filter sheet 154 would stick against panel interior wall 157, it will only abut against the crests 156B of interior wall 157 such that filtered maple syrup engaged into filtered syrup chamber 158 may still flow along troughs 156A within filtered syrup chamber 158.

Panel peripheral portion 536 includes three corner bores 542, 544 and 546 adapted to axially register with frame bores 511, 513, 515 respectively and filter sheet bores 526, 528, 530 respectively and sized and shaped accordingly for axial fluid flow therethrough. As shown in FIGS. 3 and 4, two front and aft full panels 548, 550 are respectively provided respectively at a front end and a rear end of the stack of frames 143. The front full panel 548 comprises three peripheral corner bores 552, 554 and 556. Bottom bore 552 is adapted to coaxially register with bottom bores 526, 511 and 542, the other bottom bore 554 is adapted to coaxially register with bores 528, 513 and 544, and the upper bore 556 is adapted to coaxially register with bores 530, 515 and 546. Aft full panel 550 does not include any bores.

Full panels 548, 550 also include opposite lateral side brackets 558, 560 similar to brackets 538, 540 and each include corresponding notches 558A, 560A for support and alignment by engagement over rails 504, 506.

Piston rod 525 loaded by hydraulic cylinder 522 applies continuous biasing pressure transversely against aft full panel 550 to take into sandwich between front and aft pressure plates 580 and 582 the stack of frames 143, including with all intervening frames 144, separation panels 156 and filter sheets 154. Front pressure plate 580 is fixed to carriage 508. Thus, frames 144, panels 156 and filter sheets 154 are biased against each other in a fluid-tight fashion that prevents accidental radially outward fluid escape from filtered and unfiltered maple syrup chambers 152, 158.

In use, unfiltered maple syrup liquid matrix incoming through fluid line 136 engages the pump 130 through intake 518, then is conveyed under pressure successively through upright fluid line 562, horizontal fluid line 564, oblique fluid line 566, inclined fluid line 568, inlet fluid line 570 and finally into front full panel fluid inlet bore 554 to access and be conveyed into the stack of frames 143 through an unfiltered maple syrup inlet channel formed by the axially aligned bores 554, 528, 513 and 544; as shown by arrow F1 in the drawings. The unfiltered maple syrup liquid matrix then flows transversely from this inlet channel through radial channels 148 simultaneously into the unfiltered syrup chambers 152 of all frames 144, as shown by arrows F3 in FIG. 8. With the pressure from pump 130, the maple syrup will be forced through the filter sheets 154 and be filtered from particles, including sugar sands and other particulate components, as it flows simultaneously into all filtered syrup chambers 158. There, it will flow down under the combined effect of gravity and of pump 130, along the interior walls 157 of panels 156, and particularly in troughs 156A, then out of filtered syrup chambers 158 through radial channels 584 as shown by arrows F30. From radial channels 584, the filtered maple syrup flows into a filtered syrup outlet channel formed by the axially aligned bores 552, 526, 511 and 542, as shown by arrow F2, then out through filtered syrup outlet 520 that is connected third fluid line 138.

Thus, maple syrup is filtered since passes through filter sheets 154 before reaching the filtered syrup outlet channel. Due to the flow resistance from filter sheets 154, unfiltered syrup flowing into unfiltered syrup chambers 152 will initially fill chambers 152 simultaneously. Then, pressure from pump 130 will force the liquid matrix maple syrup through all filter sheets 154 simultaneously into the filtered syrup chambers 158. This embodiment is consequently said to be in parallel mode, since all chambers 152 are filled from the filterpress apparatus simultaneously, and the maple syrup does not pass through more than one filter sheet 154.

A security unfiltered maple syrup outlet 572 is optionally provided coaxially and opposite inlet line 570. A security valve 574, normally closed, allows if opened to evacuate unfiltered maple syrup liquid matrix directly incoming from the pump 130 without the maple syrup matrix having been passed through filterpress apparatus 134.

A prewarming unfiltered maple syrup outlet 576 is optionally connected to top bores 556, 530, 515 and 540, to optionally enable unfiltered maple syrup to circulate into unfiltered syrup chambers 152 and directly out through outlet 576, for prewarming the frame stack 143 to obtain a lower maple syrup viscosity when the actual filtration process is commenced. During the prewarming stage, an outlet valve 590 located on filtered syrup outlet 520 is closed; and then opened once the prewarming is ended and the filtration process starts. A prewarming valve 592 provided on prewarming outlet 576 is opened during the prewarming process, and then closed during the filtration process.

As noted above, the maple syrup matrix may have a varying temperature when it enters the filterpress apparatus 134. As with all fluids, maple syrup viscosity decreases with increasing fluid temperature, under the Andrade equation. Moreover, as further noted above, the maple syrup may have a varying composition, for example as a consequence of higher fluid sugar concentration, which also increases maple syrup viscosity. The relationship between viscosity and capacity to flow through the filterpress apparatus 134 further defines the rheology of the fluid. The maple syrup viscosity is also closely correlated to, and is a marker of, its density, i.e., sugar concentration. Furthermore, filter sheets 154 will gradually become clogged, as will the optional diatomaceous powder P.

A consequence of the variable viscosity and composition of the maple syrup and the level of clogging of the filter sheets 154 and of the diatomaceous powder P, maple syrup would not flow through filter sheets 154 in the same way, and filtration through filterpress 134 would not occur the same way, if the speed, i.e. the power output, of pump 130 were not adjusted.

Accordingly, as suggested from the schematic view of FIG. 2 and as explained above and as further explained below, the pump 130 variable power output is managed by controller 166 to optimize the flow of maple syrup through filterpress apparatus 134.

In one embodiment, an alternate filtering device (not shown) is used instead of filter sheets 154 and optional diatomaceous powder P. Generally, in the present specification, a filtering medium will refer to any single or combination of filtration elements, including filter sheets 154, diatomaceous powder P or any other suitable filtering element.

In one embodiment, the upstream temperature and pressure sensors 160, 164 are located within the filterpress apparatus 134, at any position upstream of the filtering medium.

In one embodiment, only the pressure is measured with pressure sensor 164 downstream of pump 130 and upstream of the filtering medium. Temperature is not measured. The correlation to maple syrup viscosity and to capacity of the maple syrup to flow through the filtering medium is then only made based on this measured pressure.

As mentioned above, the power output at pump 130 is adjusted with controller 166 as a result of the pressure measured upstream of filterpress apparatus 134 by pressure sensor 164. More particularly, a setpoint pump speed—or setpoint pump power output—is defined at controller 166 for pump 130, that will vary depending on the pressure measured at sensor 164 which is meant to be of a given operational pressure value. For instance, a target pressure as measured at pressure sensor 164 might be 50 psi, but if the initial setpoint power output might were set at 50 psi at pump 130, due to high viscosity of the maple syrup liquid matrix and/or due to the filter sheets 154 being clogged, the actual measured pressure at sensor 164 might be higher, for example 57 psi. The setpoint power output at pump 130 would consequently be lowered, until the actual desired operational pressure of 50 psi measured at sensor 164 is achieved, for instance with a power output of 45 psi at pump 130. Since the composition of the maple syrup and the level of clogging of the filter sheets 154 may vary within a same batch, particularly the viscosity when the filterpress is started from a cool condition, in practice the setpoint for the pump power output may be modified continuously by controller 166, to achieve a desired constant operational pressure within filterpress apparatus of, for example, 50 psi.

The target operational pressure value measured at pressure sensor 164 may be a specific value, or may be a range, for example 50-60 psi.

The pump 130 can be of the diaphragm or of the geared type.

In one embodiment, controller 166 uses a PID (Proportional—Integral—Derivative) controller to regulate the power output of pump 130.

Controller 166 may further adjust the power output of pump 130 as a result of the temperature measured at temperature sensors 160, 162. More particularly, the temperature differential ΔT equal to the temperature measured with outlet temperature sensor 162 minus the temperature measure with inlet temperature sensor 160 indicates how much temperature is lost within filterpress apparatus 134. For instance, if filterpress apparatus is cool at initial launch of a new batch, ΔT might be greater which means that the viscosity of the maple syrup will increase during its flow through filterpress apparatus 134. For example, ΔT might then be 20° C. Controller 166 will then control the pump 130 to lower its setpoint power output even if this means that the pressure measured at pressure sensor 164 is lower than the target operational pressure value. Then, as ΔT decreases towards a determined target value, for example 5° C., the power output at pump 130 may be increased until a nominal operational pressure value associated to this ΔT value is measured at pressure sensor 164.

In one embodiment, only an outlet temperature sensor 162 is used, in addition to the pressure sensor 164, i.e. no inlet temperature sensor 160 is used. Indeed, the temperature of maple syrup liquid matrix coming from evaporator 121 and tank 124 can be predicted or evaluated relatively precisely, given the strict industry standards for boiling maple sap into maple syrup. Consequently, ΔT can be calculated from the measure temperature at outlet temperature sensor 162 minus this predicted inlet temperature value.

The alternate embodiment of maple syrup making process of FIG. 10 is similar to that of FIG. 8, with the latter 100-series numerals corresponding to 200-series numerals for FIG. 10. However, the fluid flow through the filterpress apparatus 234 is of the ‘'series mode’'. Incoming fluid flow F4 opens into a single upstream frame inner chamber 252a, thus compelling all maple syrup liquid matrix to flow therein, as opposed to the embodiment of FIG. 8 where all inner chambers 152 are filled simultaneously. Upstream frame 247 does not have an outlet port (as can be seen at the right bottom corner of FIG. 10) compared to the embodiment of FIG. 8. Instead, maple syrup filtered through filter sheet 254 in frame inner chamber 252a flows through a first filtered syrup sub-chamber 258a and then flows back into a frame inner chamber 252b. There, it passes through two more filter sheets 254 into sub-chambers 258b, then into a frame inner chamber 252c, through filter sheets 254 into sub-chambers 258c, then frame chamber 252d, through filter sheets 254 into sub-chambers 258d, and so on. F5 shows the flow direction into the frame chambers 252a, 252b, . . . while arrows F6 show the flow direction from sub-chambers 258a, 258b, etc. . . . towards a next frame chamber 252b, 252c, etc. . . . Accordingly, in this alternate embodiment of the invention, the purified maple syrup outlet (not shown) is not positioned at the front end of the filterpress apparatus but is instead located at its aft end. The purified maple syrup is brought to storage unit 142 through a fluid line (not show) similar to fluid line 138 but operatively connected to this alternate embodiment purified maple syrup outlet. In other words, in this embodiment of FIG. 10, the purified maple syrup will escape after flowing in series through the different filter sheets 254 as it is being filtered as it exits each frame inner chamber 252a, 252b, . . .

In one embodiment, the porosity of successive paper filter sheets 254 progressively decreases from upstream front end to downstream aft end of the filterpress apparatus 234, for example from an upstream porosity of 500 μm to a downstream porosity value of 5 μm, so that larger particulate components from the maple syrup liquid matrix are screened earlier at the upstream front end thereof, while smaller particulate components are screened later at the downstream aft end thereof. This allows to have the filter sheets 254 become clogged at approximately the same rate. In another alternate embodiment of the invention, the porosity of filter sheets from upstream to downstream ends of the filterpress apparatus remains at a constant value selected from any value from the group ranging for example from 500 to 5 μm.

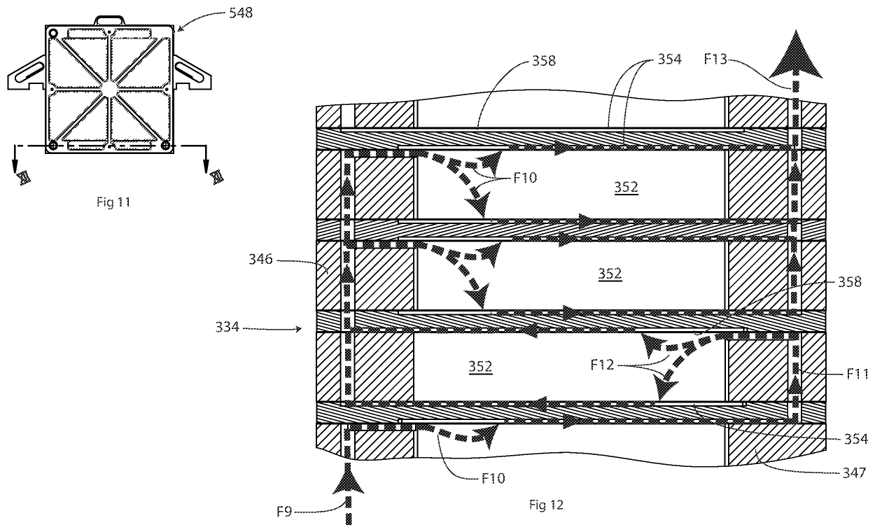

In the alternate hybrid fluid flow (parallel and series fluid flow) embodiment of the invention of FIG. 12, the reference numbers belong to a 300 series where like numerals correspond to the 100 series of the first embodiment. Filterpress apparatus 334 includes an inlet maple syrup stream F9, then “parallel mode” flow along arrows F10 and series mode flow along arrows F12, so that a combined or “mixed mode” or hybrid mode flow through system is achieved. F11 shows the flow from a filtered syrup chamber back downstream of a filter sheet 354 back into a frame inner chamber 352. F13 shows that the flow may continue further into filterpress apparatus 334 in either parallel and/or series mode.

In the embodiment of FIG. 12, the fluid outlet port (not shown) of filterpress apparatus 334 is located at the opposite end of fluid intake 570. Accordingly, in the alternate embodiment of the invention of FIG. 12, the purified maple syrup outlet does not spacedly register with front platform 516 but now extends rearwardly beyond aft full panel 550 proximate piston and cylinder 522, 526. The purified maple syrup is brought to storage unit 142 through a fluid line (not shown) similar to fluid line 138 but operatively connected to this alternate embodiment purified maple syrup outlet.

It will be understood from the embodiments of FIGS. 8, 10 and 12 that the invention may use any combination of parallel mode, series mode or hybrid mode filtration in the filterpress apparatus. The series mode filtration mode is advantageous over the known prior art parallel mode in that it allows filtering the maple syrup over a series of filter sheets (or other filtering medium). This in turn allows the porosity of the filtration mediums to be set at different values throughout the filterpress apparatus, e.g. gradually decreasing as mentioned above.

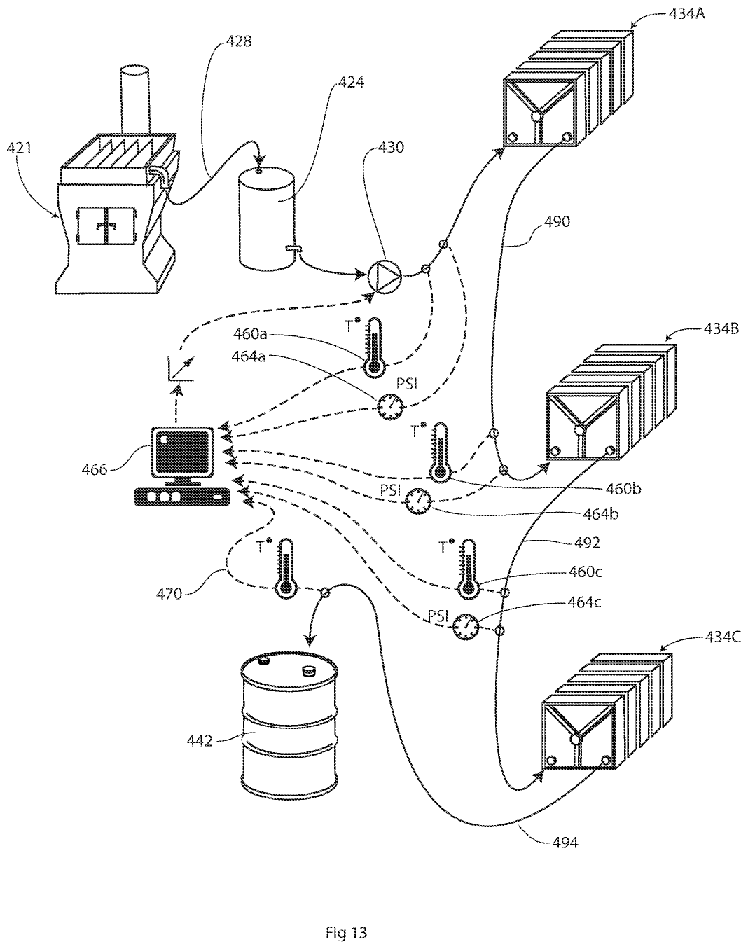

The further alternate embodiment of FIG. 13 is similar to that of FIG. 2, with 400 series numerals replacing the 100 series numerals thereof, but instead of a single filterpress apparatus 134, three such filterpress apparatuses 434A, 434B and 434C are provided, each successively connected in series via fluid lines 490 and 492, such that only the downstream filterpress apparatus 434C is fluidly connected to purified maple syrup collecting tank 442 by fluid line 494, and only the upstream filterpress apparatus 434A receives the unfiltered syrup from pump 430. Pressure sensors 464a, 464b, 464c and temperature sensors 460a, 460b, 460c may be installed upstream of the filtering medium of each filterpress apparatus 434A, 434B, 434C.

Alternately, two, four, five or more filterpress apparatuses could be provided each connected in series.

In such an embodiment with multiple filterpress apparatuses installed in series, each one of them can individually be of the parallel mode, series mode or hybrid mode, although, the parallel mode is the preferred embodiment when multiple filterpress apparatuses are used.

It can now be understood that the maple sap collected from the maple tree is a liquid matrix that may contain various macroparticulate components, including sugar sand. Accordingly, the present invention promotes fluid filtration methods of this maple sap liquid matrix to bring the latter to flow through partly permeable filter membranes or filter sheets 154, 254, 354, to screen some particulate components such as sugar sand for purified maple syrup production. These filtration membranes may also concurrently increase the overall energy requirement efficiency of concentration of maple sap density into maple syrup at an optimum density value monitored by fluid temperature and fluid pressure as described above, to allow controller 166 to control the power output of pump 130. Maple syrup density, viscosity, temperature, composition (including in respect to concentration of sugar sand), varies from season to season, varies within a same season as the season progresses, varies from one batch to another, and even varies within a same batch, notably because when maple syrup is first fed into the filterpress, the filterpress is cold and will cool the incoming syrup, increasing its viscosity; whereas later in the batch, the filterpress has been warmed up by the filtered syrup and the syrup won't be cooled as much, remaining less viscous. Consequently, having a controller capable of automatically adjusting in real-time pressure output at pump 130 is desirable, due not only to the variable parameters of the maple syrup, but also to compensate for progressive obturation of the filterpress filtering mediums themselves. Indeed, as filtration occurs, the filter sheets within the filterpress apparatus will become more and more obstructed by sugar sand and other particulate elements. The controller 166 will then automatically adjust the power output of the pump 130.

In an alternate embodiment, if the filterpress apparatus uses diatomaceous powder inside unfiltered syrup inner chambers 152, 252, 352 as an additional filtration component beyond the filter sheets 154, 254, 354 the controller may be programmed to adjust the feeding of and the manual or automated removal of the diatomaceous powder depending on the monitored temperature and pressure values if a diatomaceous powder feeder and remover are provided (not shown in the drawings).

The intention might be to maintain a constant fluid pressure within filterpress apparatus 134 inlet as measured at sensor 164; but, variable temperature of the filterpress, variable composition of the maple syrup, variable viscosity of the maple syrup (e.g. resulting from the filterpress apparatus itself being cooler at the start of the filtration of a batch of syrup), variable obturation of the filter sheets pores, and variable filtration capacity of the diatomaceous powder, might instead require the pressure at sensor 164 to be adjusted to obtain a desired optimal filtration process. Having a controller in the present invention relying on the real-time monitoring of at least the pressure at the filterpress apparatus inlet, and also on the temperature monitoring at or near the outlet of the filterpress apparatus and possibly also at the filterpress apparatus inlet, allows the power output of the variable speed pump to be adjusted in real-time without human intervention, in a much more reliable way.

Additionally, another advantageous aspect of the present invention relates to the use of series mode or hybrid mode (including partial series mode) fluid flow inside and through a filterpress apparatus; and to the use of more than one filterpress apparatuses disposed in series as in FIG. 13. This aspect of the invention allows to avoid using diatomaceous powder, as filter sheets of different porosity are used in series thus reducing the need of further fluid filtering action generated by diatomaceous powder. Indeed, in a purely parallel mode, all filter sheets are engaged simultaneously. Consequently, all of them may be of the smallest allowed porosity, to obtain the required filtration of the maple syrup. This means that all filter sheets become clogged at the same time. But, by using a system with filter sheets of gradually decreasing porosity, either in a single series or hybrid mode single filterpress apparatus, or in more than one filterpress apparatus disposed in series, the upstream filter sheets provide filtering of larger sized particulate components, while the downstream filter sheets will filter smaller particulate components, leading to a more efficient filtration process.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A maple syrup filtering process for filtering an unfiltered maple syrup liquid matrix in a maple syrup filtering system, said process comprising the steps of:
providing a maple syrup filtering system having a filterpress apparatus and a variable power output pump;
generating pressure with the variable power output pump to generate a flow of maple syrup in said filterpress apparatus from an inlet of the filterpress apparatus where the maple syrup liquid matrix is fed to an outlet where filtered maple syrup is collected;
filtering the flow of the maple syrup liquid matrix inside the filterpress apparatus with a filtering medium as the maple syrup liquid matrix flows between said filterpress inlet and outlet, to generate the filtered maple syrup from the unfiltered maple syrup liquid matrix;
monitoring fluid pressure of the maple syrup liquid matrix with a pressure sensor located upstream of the filtering medium, which fluid pressure might fluctuate as a result of at least one of a composition of the unfiltered maple syrup liquid matrix and a level of clogging of the filtering medium; and
automatically controlling, with a controller, a variable power output of the variable power output pump responsively to fluctuations in fluid pressure monitored with said pressure sensor to achieve a target pressure measured at said pressure sensor.

2. The maple syrup filtering process of claim 1, wherein the target pressure is constant.

3. The maple syrup filtering process of claim 1, wherein the target pressure varies depending on at least one of a maple syrup composition, a filtering medium clogging, and a filterpress apparatus temperature variations.

4. The maple syrup filtering process of claim 1, further comprising the step of monitoring a first fluid temperature of the unfiltered maple syrup liquid matrix with a first temperature sensor located downstream of the filtering medium, the first fluid temperature being indicative of a viscosity of the maple syrup at the outlet, wherein the step of automatically controlling, with the controller, the variable power output of the variable power output pump is also accomplished responsively to fluctuations in the first fluid temperature monitored with the first temperature sensor.

5. The maple syrup filtering process of claim 4, further comprising the step of monitoring a second fluid temperature of the filtered maple syrup with a second temperature sensor located upstream of the filtering medium, a temperature differential between the first fluid temperature and the second fluid temperature being indicative of a temperature loss within the filterpress apparatus, wherein the step of automatically controlling, with the controller, the variable power output of the variable power output pump is also accomplished responsively to this temperature differential.

6. The maple syrup filtering process of claim 5, wherein the variable power output pump is located upstream of the filtering medium and the pressure sensor, and the second temperature sensor is located downstream of the variable power output pump.

7. The maple syrup filtering process of claim 1, wherein the variable power output pump is located upstream of the filtering medium and the pressure sensor is located downstream of the variable power output pump.

8. The maple syrup filtering process of claim 1, wherein the filtering medium comprises filter sheets through which the maple syrup flows.

9. The maple syrup filtering process of claim 8, wherein said filterpress apparatus comprises a stack of frames that comprises a number of frames and separation panels each located between two corresponding frames, with said filter sheets each being disposed between a frame and a separation panel, first chambers formed within said frames and bordered by said filter sheets, second chambers formed within said separations panels and being also bordered by said filter sheets, wherein the step of generating pressure with the variable power output pump to generate a flow of maple syrup in said filterpress apparatus from the inlet to the outlet comprises circulating the maple syrup successively through said first chambers and then through said second chambers, and the step of filtering the flow of maple syrup inside the filterpress apparatus comprises the maple syrup flowing through said filter sheets when it flows from a first chamber into a second chamber.

10. The maple syrup filtering process of claim 9, wherein said separation panels have an uneven surface to help avoid flat engagement of said filter sheets against a surface of the separation panels.

11. The maple syrup filtering process of claim 9, wherein the filtering medium further comprises diatomaceous powder located in at least some of said first chambers through which the unfiltered maple syrup flows.

12. A maple syrup filterpress apparatus for filtering particles from an unfiltered maple syrup liquid matrix, said maple syrup filterpress apparatus comprising:
a housing;
a number of interconnected first and second chambers within said housing;
filtering mediums each between one of said first chambers and one of said second chambers for filtering particles in the unfiltered maple syrup liquid matrix as it flows from said first chambers to said second chambers;
an unfiltered maple syrup liquid matrix inlet connected to at least one of said first chambers for allowing the unfiltered maple syrup liquid matrix to be fed to said at least one of said first chambers that is connected to said inlet;
a filtered maple syrup outlet connected to at least one of said second chambers for allowing filtered maple syrup to be collected from said at least one of said second chambers that is connected to said outlet; and
a pump generating pressure in said housing to force maple syrup to flow from said inlet, through said first and second chambers with said maple syrup being filtered as it passes from said first chambers to said second chambers by said filtering mediums, and out through said outlet,
wherein at least part of the maple syrup flows from one of said second chambers into one of said first chambers whereby the maple syrup is filtered in series by at least two of said filtering mediums.

13. The maple syrup filterpress apparatus of claim 12, wherein between said at least one of said first chambers which is connected to the inlet and said at least one of said second chambers connected to the outlet, said maple syrup flows alternately from said first chambers into said second chambers a number of times to be filtered in series by all filtering mediums.

14. The maple syrup filterpress apparatus of claim 13, wherein the filtering mediums comprise filter sheets each disposed between corresponding ones of said first and second chambers.

15. The maple syrup filterpress apparatus of claim 14, wherein a porosity of said filter sheets has value ranging between 5 to 500 micrometers.

16. The maple syrup filterpress apparatus of claim 15, wherein the porosity of said filter sheets decreases between higher upstream porosity values to lower downstream porosity values in said filterpress apparatus.

17. The maple syrup filterpress apparatus of claim 14, wherein said housing comprises a stack of frames that comprises a number of frames, and separations panels each located between two corresponding frames, with said filter sheets each being disposed between a frame and a separation panel, with said first chambers being formed within said frames and bordered by said filter sheets, with said second chambers being formed within said separations panels and being also bordered by said filter sheets.

18. The maple syrup filterpress apparatus of claim 17, wherein said separation panels have an uneven surface to help avoid flat engagement of said filter sheets against the separation panel surface.

19. The maple syrup filterpress apparatus of claim 13, wherein said filtering medium further comprises diatomaceous powder in at least some of said first chambers.

20. The maple syrup filterpress apparatus of claim 19, wherein a granulometry of said diatomaceous powder ranges between 5 and 1,000 micrometers.
